(19) United States
(12) Patent Application Publication
(10) Pub. No.: US 2005/0057522 A1
(43) Pub. Date: Mar. 17, 2005

(54) Large touch-sensitive area with time-controlled and location-controlled emitter and receiver modules

(76) Inventor: Franc Godler, Senftenberg (DE)

Correspondence Address: GOODWIN PROCTER L.L.P, 103 EISENHOWER PARKWAY, ROSELAND, NJ, 07068, US

(21) Appl. No.: 10/471,069

(22) PCT Filed: Mar. 6, 2002
(86) PCT No.: PCT/DE02/01131

(30) Foreign Application Priority Data
Mar. 7, 2001 (DE) 101 10 744.7

(51) Int. Cl. G09G 5/00

(52) U.S. Cl. 345/173

(57) ABSTRACT

The invention enables the realization of an optical and electronic structure of a touch-sensitive area on any flat display surface such as a monitor. The optical structure does not require any additional optical components such as lenses. Laser diodes are likewise not required for the operation of a structure of this type. Large distances and, nevertheless, high sensitivity and high resolution of the touch-sensitive area are accomplished by a novel time-control and location-control of both the emitter diodes as well as the receiver diodes or receiver photo-transistors. If still or moving images are displayed on the surface, the invention can be used as a touch screen and can interactively control the display. A central module simulates a computer mouse and a keyboard.

The invention relates to the optical and electronic structure of a very large (possibly over 0.04 m², typically: >1 m²) touch-sensitive area (also called a touchscreen) on any transparent surface (monitor), which is used to build multi-active display windows, multi-active boxes, information terminals, or security systems, e.g., in the form of personnel filters. This invention describes the application of a multi-active display window, whose entire area, up to 8 m×8 m, can be configured interactively for the first time. Here, the resolution of the scan equals ±1.5 mm.

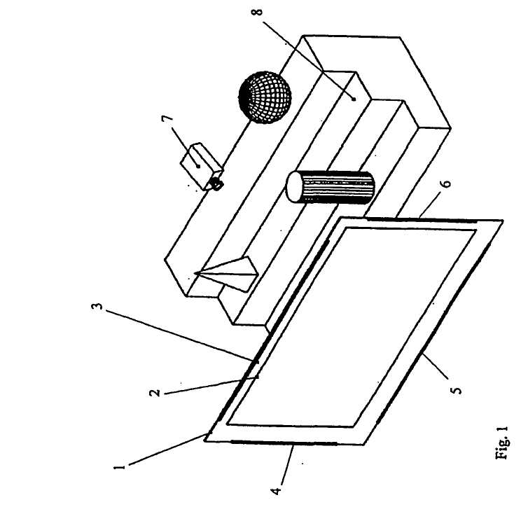

For the application as a multi-active display window (FIG. 1), a focusing screen, projection film, or another projection surface (2), which replaces part of or the entire decoration (8), is set up behind the display window panel (1). On this surface, a large-area image is projected (rear projection) from behind by means of a known video and data light projector (7). These images are typically generated by a control computer. At the border of the display window panel, a vandalism-proof coating is applied from the outside. This contains a special infrared (IR) emitter and receiver module arrays (3, 4, 5, 6), which cover the display window (the touch-sensitive area) with an invisible light-barrier curtain. From the front, the user can point to a certain area of the image (user input). This area is identified by the structure according to the invention described in this patent specification and forwarded to the control computer. This computer can control the further flow of images and graphics corresponding to the user input. Thus, an interactive, i.e., user-controlled, presentation is possible. Here, this user input need not absolutely lie on the area given by the rear projection; instead, a separately designated area (e.g., a keyboard or trackball) can also be on the touch-sensitive area. Furthermore, the described detection structure can also be applied to other optical systems and image generators, which generate images on surfaces (plasma screens, large monitors, LCD monitors, rear-projection boxes, etc.).

The presentation processed in the control computer can consist of, e.g., an Internet presentation. The multi-active display window can then be functionally compared with a computer mouse and its navigation properties. Thus, for the first time economical (without personnel and around the clock) information and advertisements can be provided for any supplier at locations in cities that are heavily frequented by pedestrians.

For the current state of the art, touch-sensitive surfaces up to approximately 40″ (touchscreens) are realized preferably in the type in which a film or a number of thin conductive threads on the image surface detects the user input (touch) because an electrical property of the film or the thread (e.g., resistance, capacitance, field strength) changes when touched, and this change is converted into the exact two-dimensional position of the user input by evaluating the separately detected horizontal and vertical electrical signals.

The disadvantages of these methods are the following:
1) The cost of the structure greatly increases with the size of the touch-sensitive area. Surfaces over approximately 0.5 m² thus cannot be realized economically.
2) The accuracy of the touch detection decreases with larger surfaces.
3) The described methods are unsuitable for use in public areas, because they are not vandalism-proof. This means that they can be easily destroyed and can no longer fulfill their intended function due to outside actions of a willfully destructive nature.
4) Most solutions of the state of the art require additional layers over the projected image and thus attenuate the brightness of the image.

Other possibilities include the acoustic (ultrasound) detection of the interrupt, wherein fewer emitters/receivers are necessary than for two-dimensional networks. However, this technology is reliable only up to touchscreen sizes of approximately 1.5×1.5 m² and shows disadvantages for the reliable detection of user input in the edge regions.

There are also active detection systems. Active means that the user uses a special, active transmitting pointing device in order to perform the user input (flip-chart). This system is not suitable if anonymous persons are to benefit from the interactivity, e.g., of the multi-active display window.

In addition, for small touchscreens (e.g., in automatic bank machines), detectors based on infrared emitters and receivers are used. Here, the touch-sensitive surface is covered with invisible IR radiation and the interruption of a light barrier is detected. The emitters and receivers are turned on permanently. Usually, additional lenses are used for increasing the light-beam focusing for such structures. Therefore, only small surfaces (<0.1 m²) can be detected, because for greater distances from the emitter units to the receiver units, strong cross-coupling prevents the detection of the user input and also the light intensity of the diodes is no longer sufficient to achieve reliable detection.

It is known, e.g., for infrared light-emitting diodes (IR-LED) from remote controls, that LEDs can be operated in a pulsed mode up to pulse duty factors of 1:100. This means that the LED is turned off one-hundred times longer than the time during which it is turned on (and thus emits light). Here, pulse sequences (bursts) with rectangular signals are forwarded to the emitter, which produce a more or less sinusoidal light stream based on their self-capacitance and the pn-junction properties. The electrical current during the short on period can then equal 100-times the nominal continuous current without significantly affecting the life of the LED. Thus, considerably higher peak powers of the light radiation can be achieved in a short time period than would be possible for continuous operation.

It is further known that IR-LEDs and IR receivers (IR-sensitive photodiodes, phototransistors, or photoresistors) can be used in light barriers. Here, the interruption of the optical connection between emitter and receiver (when the emitter and receiver “are looking at” each other) or the formation of the optical connection (when the emitter and receiver see each other only if a third object reflects the emitted light) is detected and, e.g., it is determined whether a person has passed through a certain space or whether a person is located in front of a certain point in space.

An embodiment of the invention is explained in more detail with reference to the enclosed drawings. Shown are:

FIG. 1, a schematic structure of a multi-active display window,

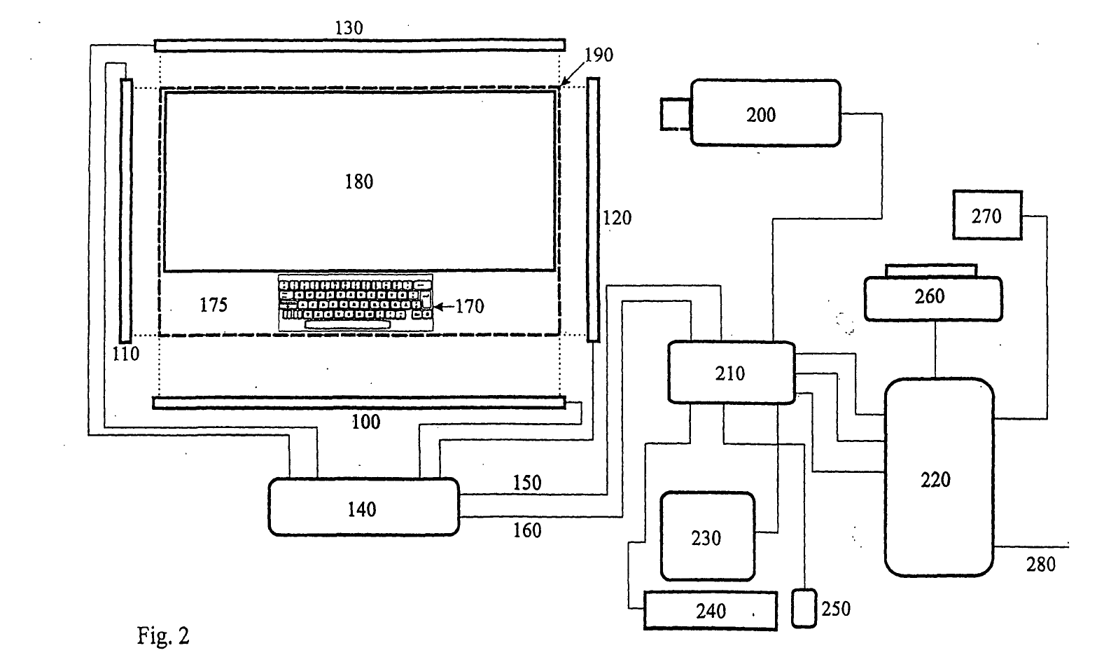

FIG. 2, a block diagram of a large-area, interactive projection,

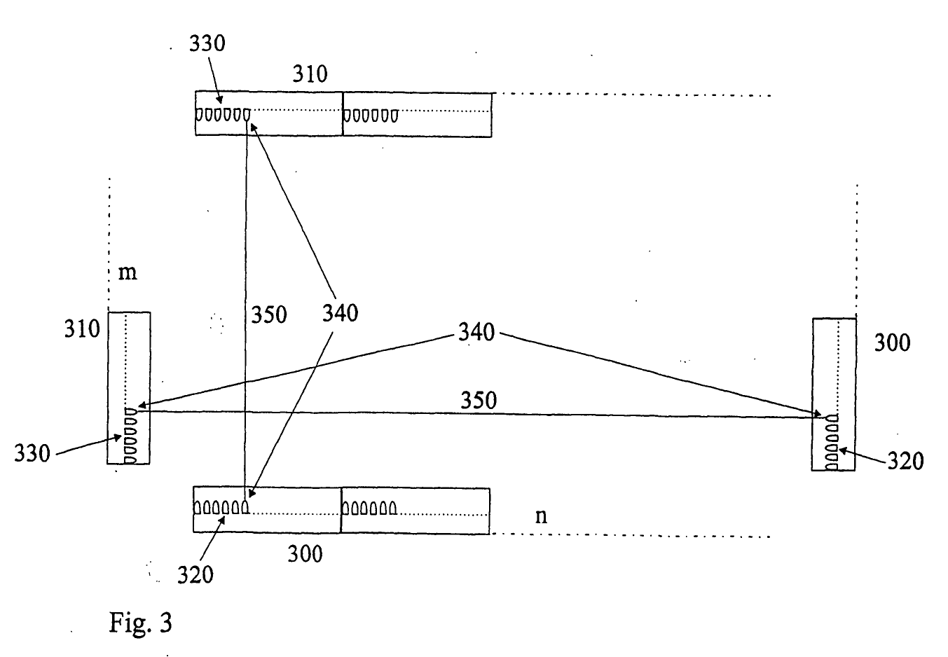

FIG. 3, the structure of the time-controlled and position-controlled light barriers.

The disadvantages mentioned above of previous touchscreen solutions for large surfaces do not occur for a configuration of the touchscreen according to the invention. In connection with a rear projection by means of contemporary high-power LCD or DMD video and data projectors, large display windows can be transformed into multi-active projection surfaces (FIG. 1), which fulfill the following properties:
1) Economical provision of the display window with a touch-sensitive surface.
2) Vandalism-proof structure.
3) Reliable detection of a user input for a finger width greater than 10 mm (small children) with a position resolution of ±1.5 mm without any light loss of the projection.
4) Completely automatic day and night operation possible due to high-power, remote-control capable projectors.

According to the invention, these requirements are fulfilled by detecting the user input through electromagnetic (typically in the infrared range of the spectrum) emitters and receivers, which are arranged in the horizontal and vertical direction and which are controlled in a suitable way in a time-sequenced and position-dependent pattern. These transmitters and receivers are each arranged separately in modules (transmitters and receiver modules FIG. 3, 300, 310), which can be arranged in series in principle in an arbitrary amount (FIG. 2, 100, 110, 120, 130). These modules are attached on the outside around the touch-sensitive area (190) to be defined, wherein the modules can be mounted at a large distance to the borders of the area (up to 8 m from each other), which creates the ability of “hiding” these components in terms of construction. Because the modules are installed in stable aluminum, steel, or diecast housings, this arrangement is vandalism-proof. The emitter and receiver modules 300, 310 are arranged opposite each other and “look” out over nearly the entire touch-sensitive area 190 (the distance from the display window surface here equals approximately 0.5 to 3 cm). Each module (300, 310) has its own microcontroller, which is arranged in the module itself. The entire arrangement represents a multiprocessor system. Also, the central module 140 has a microcontroller with greater capability relative to the module controllers (greater RAM capacity, higher clock frequency, larger flash-RAM). The emitter modules 300 receive their control signals from the central module 140. The measurement signals of the receiver modules 310 are analyzed statistically and then transmitted to the central module 140.

The central module 140 assembles the entire interactive surface and recognizes a relevant user input. This input is output, e.g., in a special protocol (e.g., standard serial interface for a mouse) to the PC. Other output types, such as x-coordinates, y-coordinates (for special consoles), or PS2-mouse emulation can be set by the attached PC. The central module allows the implementation of arbitrary mouse protocols or serial transmission protocols based on the microcontroller circuit. The data is transmitted to the control computer 220 controlling the presentation.

A preferred configuration of the invention is described in the following (FIG. 2, FIG. 3):

The touchscreen consists of IR-emitter and IR-receiver modules (300, 310), which are arranged together into corresponding horizontal and vertical emitter and receiver module arrays (100, 110, 120, 130). Here, the number of active emitter modules in the horizontal (or vertical) direction n (or m) must agree with the number of active receiver modules in the horizontal (vertical) direction. Here, m can not equal n. Thus, any rectangular area 190 can be defined. In the preferred example, n, m should not be greater than 16. For example, for a structural module length of 16 cm (16 emitters 300 or receivers 310 are assembled on a module and the distance of the emitter diodes or receiver transistors to each module is 10 mm), user inputs on a maximum surface area of 2.56×2.56 m² (6.55 m²) can be detected in this embodiment. In principle, larger areas with a configuration according to the invention are possible. The emitter and receiver module arrays (100, 110, 120, 130) must not be mounted directly on the touch-sensitive area 190, but instead can feature a distance, which in principle is arbitrarily large, from the area (FIG. 2). The corresponding two emitter and receiver module arrays (which in turn consist of n or m modules) are connected to a central module 140. In the preferred configuration of the invention, the central module 140 automatically notices how many modules make up the units in the x-direction (horizontal) and y-direction (vertical). In this preferred configuration, next to the active region 190, which is predetermined by the size of the projected image, yet another touch-sensitive area 170 can be defined, which can be used as a keyboard and/or trackball for data input to the control computer (PC) 220. Therefore, in the total possible touch-sensitive area, allowed zones (180 and 170) and not-allowed zones (175) are created. The connection from the central module 140 to the control computer (PC) 220 is realized in this configuration by two interfaces, one functions as a mouse 150, one as a keyboard 160, and by a keyboard, mouse, and monitor changeover switch 210. An additional mouse 250 and an additional keyboard 240 can be installed for fitting the entire system directly at the site of the control computer (PC) 220, which can be in a different room.

In the following, the type of control of the individual emitter diodes and receiver phototransistors (320, 330) is described. Instead of the phototransistors, naturally other optical receivers, such as, e.g., photodiodes or photo-elements can also be used. The control is distinguished by the following fundamental properties:
1) Only one opposing pair 340 of emitter/receiver diodes of a emitter/receiver unit are ever turned on. This means that an emitter diode emits (in general) IR light, while in this time period t_{D} only the opposing receiver diode is turned on (only its signal amplifier amplifies the incident signal). After a certain time Δ_{diode} this pair is turned off and the next is pair turned on. After one cycle (scan) over all the diode pairs is completed, the cycle begins again with the first pair. It is useful to scan the horizontal and vertical diodes simultaneously (so that two emitter diodes and two receiver diodes are always turned on, one from the horizontal and one from the vertical emitter/receiver unit). The sequence of diodes to be turned on is completely arbitrary, but for the sake of control simplicity they should be turned on in series. A typical value for Δt_{diode} is currently around 200 μs. A faster or slower control for other applications (e.g., security technology, monitoring areas) is possible. Thus, using a maximum of 16 modules each with 16 diodes produces 256 diodes per emitter/receiver unit and a time of approximately 50 ms for one scan (this corresponds to a total scanning frequency of approximately 20 Hz).
2) The paired operation of the emitter and receiver diodes spares the use of expensive optics for focusing the emitted light. These would otherwise be necessary to prevent cross-coupling between the receivers over such large distances. For the same reason, simple IR-diodes with small beam angles are sufficient. No laser diodes are used (which would be more expensive many times over).
3) During the short on time Δt_{diode} of an emitter diode 320, this diode is operated at a multiple of the nominal continuous power (current-regulated or voltage-regulated). The light emission during time Δt_{diode} is thus a multiple over its nominal continuous light power. Because each IR-LED is turned off during the remaining time of a scan, this means no restriction on the life of the diodes. For this reason, the distance of the emitter and receiver units to the touch-sensitive surface can be large (up to 8 m total distance has already been demonstrated). Because the emitter and receiver arrays are to enable the scanning of a large sensitive area, a normal pulsed solution, like those in remote controls with normal rectangular voltage level control or even sinusoidal control, is no longer possible. Here, the diode must be considered as a component with depletion layer capacitance, charge carrier lifetime, and charge carrier mobility. These factors produce the necessity of generating massive saturation at turn on through the turn-on voltage amplitude and through a build-up time that lies in the region of a few ns. To achieve such control behavior, different methods, such as the use of high-power, fast switching transistors or corresponding logic with re-differentiation and amplification can be used. Through this saturation, no pulse sequence in the kHz range is possible for the normal LED, because there are too many charge carriers in the pn junction. A pulse sequence with this control produces a single flash of light, which fades in the range of μs after turning off the pulse sequence. To prevent this property, the emitter diode must be discharged of charge carriers again directly after saturation. For this purpose, there are various possibilities, e.g., the use of an additional discharging transistor or simply a parallel load resistor. The result is the generation of short, very intense flashes of light, which are emitted as a sequence (burst) and which are used later in the receiver as the basis for a high signal-to-noise ratio. The microcontrollers in the emitter modules permit both controls to be set individually in order to minimize possible reflections on the display window panel or projection plane. In the preferred configuration of the invention, according to the size of the interactive surface, 10-15 pulses are emitted per burst.
4) During their on time, the IR-LEDs 320 are operated not at a constant power, but instead in the so-called burst-mode. This means they are operated with a frequency f, which clearly lies over the frequency of the relaying of the diodes f>1/Δt_{diode}. Typically, this frequency lies in the kHz range.
5) The amplification circuit of detectors 330 in the receiver unit features a high attenuation (low amplification) for frequencies not equal to the burst frequency f, but a low attenuation (high amplification) at the burst frequency f. Therefore, ambient lighting affects (daylight, 50 Hz ripple frequency from power-line lamps, etc.) are effectively suppressed. The input circuit of the receiver, however, has no normal filter (LC, RC) as a working resistor, but instead uses only an inductor as a working resistor. Therefore, two significant advantages are produced: first, disruption by constant light (daylight, street lamps) or light with amplitude modulation in small frequency ranges (50 Hz, 100 Hz) is no longer possible. In this case, the coil acts as a short circuit. Second, the operating point of the phototransistors even for strong incident sunlight is not shifted so far that the usable signal can no longer be detected. For burst analysis, no filter or PLL system is used. After the build-up time, an integrator is turned on, which permits continuous average value formation. The integration time has a ratio of 1:3 to the total time of one burst. By means of a comparator, a nearly 100% detection likelihood of the interrupts of the light barrier is obtained for large distances between emitter and receiver. The receiver components can be influenced in their sensitivity with the aid of the microcontroller by the beginning of the integration and by the period of the integration relative to the burst time. This allows a flexible and automatic adaptation to the total distance of the emitter and receiver arrays.
6) For further increase of the reliable detection also of narrower interrupts and the resolution capability (positional resolution of the detection of the interrupt), not only can the diode lying exactly opposite the currently operating receiver (pair 340) be turned on, but also its direct neighbor. The emitter on time then decreases to ⅓ of the receiver on time. Other time sequences/positional combinations are also possible. To touch the interactive surface, usually only one finger (index finger) is used. The index finger of small children has an average diameter of 10 mm, that of adults approximately 18 mm. The distance of the light barriers equals 10 mm in the x-direction and y-direction. In the normal case, an adult always interrupts more than one light barrier and can thus be detected at 100%. In the worst case, a small child can hold a finger between two light barriers, so that residual light radiation like from one-sided screen shading is always still seen by the receiver.

To achieve a higher detection likelihood for smaller objects, which can interrupt the beam path, the following controls of the receiver and emitter are possible. Starting with emitter LEDs with 5 mm φ, 10 mm distance to neighbor LED, and a beam angle of ±8°, the following results were calculated for the statistical evaluation to resolve an interrupt with 100% reliability at any position within the active region (resolution of the position <±1.5 mm).

a) Turned on during the integration time are:
receiver n and emitter n continuously: the finger thickness must be at least 15 mm in the entire interactive region to be detected at 100% with a resolution of ±1.5 mm with additional evaluation in the central module 140 (additional evaluation is described farther below).

b) The emitters n−1, n, and n+1 are turned on one after the other during the integration time of the receiver n. The receiver signals are evaluated as a function of which emitter is currently active.

c) The emitters n−3, n−1, n, n+1, n+3 are turned on one after the other during the integration time of the receiver n. The receiver signals are evaluated as a function of which emitter is currently active.

Other arbitrary combinations of emitter control relative to the receiver are conceivable. The burst on-time period is here lengthened correspondingly. Because the total distance between the emitter and receiver arrays is usually greater than the projected image and thus the desired interactive region, in most cases the control according to method b) makes the most sense. However, by means of microcontroller technology, if desired, version a) or c) can also be set. Other settings of the total control are possible. All controls except 1) allow the reliable detection of a finger thickness>10 mm.
7) If the emitter and receiver units (100, 110, 120, 130) are located at a large distance to each other and directly in front of a very reflective surface (display window), then in addition to the electronic regulation, the emitter and receiver modules (300, 310) can also be installed in a housing, such that a screen is created only in the surface of the projection, which prevents the emitted light of the emitter diodes from reaching the reflective surface, and thus prevents beam interruption, and thus detection. This screen can also be mounted as a separate part.

8) In addition to the combination of relative emitter changeover with reference to the integration of a receiver, which significantly increases the detection likelihood of smaller objects, a basic statistical analysis concerning interruptions of the light barriers in position and time is performed in the central module 140. This produces a higher resolution of the scanning up to approximately 1 mm. An average value formation of the interruptions over 3 adjacent light barriers and in addition a time analysis over three scans in sequence permit the reliable detection of the user and the input location. In addition, short interruptions, e.g., insects, are excluded. Longer interruptions (opaque object on a light barrier area) can also be filtered out after the recognition time (20-40 s). In addition, an event is interpreted as true only if x and y light barriers are interrupted for a minimum time.
9) The central module 140 emulates a standard serial mouse relative to the control computer (PC) 220. Thus, this system can be used immediately for all operating systems (e.g., Windows 95/98/2000 or Linux) and computer types (e.g., PCs, workstations). If the user leaves the interactive region at a position x₁, y₁, then the pressing of the left mouse button at this position is reported to the control computer by the central module. Because the central module is built with a microcontroller, the emulation of the direct output of x-coordinates and y-coordinates for video games or a PS2 mouse can also be executed in firmware. Other interface protocols can be loaded by the control computer at any time into the central module. In addition to the mouse emulation, the central module 140 can emulate a standard IBM keyboard (150, 160) if desired.

A typical user input and its detection then look like this:

The user brings his finger close to the touch-sensitive surface (display window) to touch an image region displayed by the projector. After a certain cycling of the scanning of all emitter and receiver diodes, several receiver diodes in the horizontal and vertical direction determine a light interruption. This information is converted in the central module 140 into a position of the user interruption and can be transmitted to the control computer, e.g., as the position of the mouse pointer. For the next scan cycle, the focus of the interrupt is possibly located at a different position (because one scan only lasts 1/20 of a second, the position of the interrupt changes only slowly). If after a certain scan an interruption is no longer determined, then the user has removed his finger from the sensitive zone. This action can be transmitted to the control computer from the central module as a mouse click. Then the control computer can display new image contents corresponding to the mouse click on the touch-sensitive surface by the projector.

According to the invention, there are also configurations with an unequal number of emitter and receiver diodes in the emitter and receiver units. For large distances from the emitter unit to the touch-sensitive surface, emitter diodes can thus be spared. The resolution is then determined by the distance of the receiver diodes.

Another configuration according to the invention consists in that the emitter and receiver diodes are not arranged in different modules and emitter and receiver units, but instead alternating or in parallel on one side. On the opposite side, there is then either a reflective or absorbing unit. In the first case, the detection is completely analogous to the description above. In the second case, the light back-scattered by the user input (typically a finger) is used for detection (no light barrier interrupt is detected, instead the light barrier closing is detected). The absorption device in the opposite region prevents an unintended closing of the light barriers. The control of adjacent emitter and receiver diodes otherwise follows the path described in points 1-8.

A preferred configuration of the installation of the touch-sensitive surface is that shown in FIG. 1. Here, a data and video projector illuminates from behind a rear-projection surface (normal focusing screen, holographic rear-projection screen, e.g., HoloPro© from Pronova for better suppression of ambient light) located behind a display window. The touch-sensitive surface is built on the display window. The holders of the emitter and receiver units can be “hidden” in the frame of the display window screen. For a typical projection surface of 1.6 m², a transmission of the focusing screen of 50%, a light-amplification factor of the focusing screen in the forward direction of 2, an ambient brightness on the display window of 2000 lx (shaded outside area), and a degree of reflection for this light of approximately 35%, a projector with an optical power of approximately 2300 ANSII lumens is required to achieve twice as much light as the ambient light on the focusing screen. For the use of a HoloPro™ screen, this ratio is even more favorable. A touch-sensitive display window can be used for advertisement anywhere in an outside area, whether in pedestrian zones, at exhibitions, in auto dealers, etc. Other applications of the touch-sensitive surface are large, enclosed rear-projection boxes (multi-active boxes) or smaller information terminals in railroad stations or airports.

List of Reference Symbols

FIG. 1

Key:

1 Glass panel of the display window
2 Projection surface
3 Strip with receiver modules
4 Strip with receiver modules
5 Strip with emitter modules
6 Strip with emitter modules
7 Video-data projector
8 Decoration
   FIG. 2
   Key:
100 Strip with emitter modules
110 Strip with receiver modules
120 Strip with emitter modules
130 Strip with receiver modules
140 Central module
150 Mouse output
160 Keyboard output
170 Film with keyboard image
175 Not used area
180 Projection surface (image surface)
190 Touch-sensitive area
200 Video-data projector
210 Mouse-keyboard-monitor changeover switch
220 Computer
230 Monitor
240 Keyboard
250 Mouse
260 Printer
270 Card reader
280 LAN connection
   FIG. 3
   Key:
300 Emitter module
310 Receiver module
320 Emitter diodes
330 Receiver phototransistors or diodes
340 Emitter-receiver pair
350 IR light beam

1. A touch-sensitive region on a display device for detecting a user input, comprising:
emitter diodes for outputting light;
receiver diodes/phototransistors for detecting the light, the emitter diodes and receiver diodes/phototransistors being arranged in vertical and horizontal emitter and receiver units set opposite to each other, one of the emitter diodes and one of the receiver diodes/phototransistors being optically set in a direct paired relationship to each other; and
a central module;
wherein the detection of a user input is realized through continuously repeating time-sequenced and position-sequenced on-and-off switching of individual emitter diodes and receiver diodes/phototransistors;
wherein one of the emitter diodes and one of the receiver diodes/phototransistors are controlled in pairs; and
wherein for evaluating and increasing the resolution, the signals of the emitter diodes are referenced, adjacent to the emitter diodes, and all electrical signals of the receiver diodes/phototransistors are assembled into the central module, and also the emitter diodes are controlled from the Central module, such that the emitter diodes output a plurality of pulses, whose integrative, quantitative evaluation is a measure of the position of the interruption of a light barrier during an evaluation period and provides information on the position of the interruption relative to the emitter diodes.

2. A touch-sensitive region according to claim 1, characterized in that the emitter diodes are operated during their short on-time with higher power than their nominal continuous power.

3. A touch-sensitive region according to claim 1, characterized in that the wavelength of the applied electromagnetic radiation is in the infrared range of the spectrum and the emitter diodes and receiver diodes/phototransistors are emitting and receiving semiconductor elements.

4. A touch-sensitive region according to claim 1, characterized in that the emitter diodes are operated with a burst signal during their on time, which means that the electrical alternating signal controlling them has a higher frequency f than the alternating frequency of the emitter diodes controlled one after the other; wherein for faster saturation, measures, such as increasing the start-up voltage amplitude/voltage rise time and necessary discharge of charge carriers from the emitter diodes after the saturation pulse, are used.

5. A touch-sensitive region according to claim 1, characterized in that the amplifier circuit of the receiver diodes or phototransistors has a large amplification at the burst frequency f and otherwise enables a high attenuation through an inductive operating resistor followed by an integrator.

6. A touch-sensitive region according to claim 1, characterized in that not only the emitter diodes arranged optically in pairs with a receiver diode or phototransistor are active during the on time of the receiver diode or phototransistor, but adjacent emitter diodes are also active.

7. A touch-sensitive region according to claim 1, characterized in that an optical aperture is arranged in front of the emitter diodes and receiver diodes or phototransistors.

8. A touch-sensitive region according to claim 1, characterized in that the optical paired relationship of emitter diodes and receiver diodes or phototransistors involves oppositely positioned emitter diodes and receiver diodes or phototransistors in opposing emitter and receiver units.

9. A touch-sensitive region according to claim 1, characterized in that the optically paired relationship of the emitter diodes and receiver diodes or phototransistors involves emitter diodes and receiver diodes or phototransistors positioned one next to the other in a mixed emitter and receiver unit and an oppositely positioned mirror surface.

10. A touch-sensitive region according to claim 1, characterized in that the optical relationship of the emitter diodes and receiver diodes or phototransistors involves emitter diodes and receiver diodes or phototransistors positioned one next to the other in a mixed emitter and receiver unit and an oppositely positioned absorbing surface.

11. A touch-sensitive region according to claim 1, characterized in that the total number of emitter diodes in the emitter units is exactly equal to or not equal to the number of receiver diodes or phototransistors in the receiver units.

12. A touch-sensitive region according to claim 1, characterized in that a microprocessor of the central module calculates the position of the user input from digital receiver module signals by means of a statistical analysis method.

13. A touch-sensitive region according to claim 1, characterized in that the central module can simulate any arbitrary interface relative to an attached computer.

14. A touch-sensitive region according to claim 2, characterized in that the wavelength of the applied electromagnetic radiation is in the infrared range of the spectrum and the emitter diodes and receiver diodes/phototransistors are emitting and receiving semiconductor elements.

15. A touch-sensitive region according to claim 2, characterized in that the emitter diodes are operated with a burst signal during their on time, which means that the electrical alternating signal controlling them has a higher frequency f than the alternating frequency of the emitter diodes controlled one after the other; wherein for faster saturation, measures, such as increasing the start-up voltage amplitude/voltage rise time and necessary discharge of charge carriers from the emitter diodes after the saturation pulse, are used.

16. A touch-sensitive region according to claim 3, characterized in that the emitter diodes are operated with a burst signal during their on time, which means that the electrical alternating signal controlling them has a higher frequency f than the alternating frequency of the emitter diodes controlled one after the other; wherein for faster saturation, measures, such as increasing the start-up voltage amplitude/voltage rise time and necessary discharge of charge carriers from the emitter diodes after the saturation pulse, are used.

17. A touch-sensitive region according to claim 2, characterized in that the amplifier circuit of the receiver diodes or phototransistors has a large amplification at the burst frequency f and otherwise enables a high attenuation through an inductive operating resistor followed by an integrator.

18. A touch-sensitive region according to claim 3, characterized in that the amplifier circuit of the receiver diodes or phototransistors has a large amplification at the burst frequency f and otherwise enables a high attenuation through an inductive operating resistor followed by an integrator.

19. A touch-sensitive region according to claim 4, characterized in that the amplifier circuit of the receiver diodes or phototransistors has a large amplification at the burst frequency f and otherwise enables a high attenuation through an inductive operating resistor followed by an integrator.

20. A touch-sensitive region according to claim 2, characterized in that not only the emitter diodes arranged optically in pairs with a receiver diode or phototransistor are active during the on time of the receiver diode or phototransistor, but adjacent emitter diodes are also active.
